(19) United States
(12) Patent Application Publication
(10) Pub. No.: US 2016/0095023 A1
(43) Pub. Date: Mar. 31, 2016

(54) REDUCING ATTACH DELAY FOR A MULTI-SIM UE

(71) Applicant: QUALCOMM Incorporated, San Diego, CA (US)

(72) Inventors: Ajith Tom Payyappilly, San Diego, CA (US); Michele Berionne, San Diego, CA (US); Juan Zhang, San Diego, CA (US); Gerardo Giaretta, Monteviale (IT)

(21) Appl. No.: 14/867,343

(22) Filed: Sep. 28, 2015

Related U.S. Application Data
(60) Provisional application No. 62/057,345, filed on Sep. 30, 2014.

(51) Int. Cl. H04W 36/00; H04W 36/14; H04W 8/18

(52) U.S. Cl. CPC H04W 36/0061; H04W 8/183; H04W 36/14; H04W 88/06

(57) ABSTRACT

Methods, systems, and devices are described for wireless communication. A modem processor of a user equipment (UE) may receive a switch indication directing the modem to utilize a designated SIM and may access identification (ID) information from the SIM, including ID information for a network operator. The modem processor may then retrieve a stored access point name (APN) associated with the network operator and establish a connection to the data network identified by the stored APN. In some cases, the APN may be stored in the modem processor after a successful connection to the data network using the designated SIM. In some cases, the UE may also identify a network priority rule associated with the network operator of the SIM and establish the connection to the data network based on the priority rule.

### CROSS REFERENCES

The present Application for Patent claims priority to U.S. Provisional Patent Application No. 62/057,345 by Payyappilly et al., entitled “Reducing Attach Delay for a Multi-SIM UE,” filed Sep. 30, 2014, assigned to the assignee hereof, and expressly incorporated by reference herein.

### BACKGROUND

1. Field of Disclosure

The following relates generally to wireless communication, and more specifically to reducing attach delay for a multi-subscriber identity module (SIM) user equipment (UE).

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

Examples of such multiple-access systems include code division multiple access (CDMA) systems, time division multiple access (TDMA) systems, frequency division multiple access (FDMA) systems, and orthogonal frequency division multiple access (OFDMA) systems, e.g., a Long Term Evolution (LTE) system.

By way of example, a wireless multiple-access communications system may include a number of base stations, each simultaneously supporting communication for multiple communication devices, which may be otherwise known as a UE. A base station may communicate with UEs on downlink channels (e.g., for transmissions from a base station to a UE) and uplink channels (e.g., for transmissions from a UE to a base station).

In some cases, a UE may support multiple subscriptions to one or more network operators. For example, a UE may contain multiple SIM cards, each of which may correspond to a unique subscriber identity. In some cases, a UE application may direct a change from one subscriber identity to another, which may involve a transition from one network operator to another. In some cases, an application processor of the UE may contain a table mapping the different network operators with different access point names (APNs). However, in some cases, a modem processor of the UE may not have access to the APN data.

Thus, in some cases, when a UE makes a transition from one network operator to another (e.g., when an application on the UE directs a switch to another SIM card), the modem processor may not have access to the appropriate APN for the new network, which may result in a delay. For example, the UE may pass the incorrect APN to the new network, which may result in a failed internet protocol (IP) connection. This may also result in a failure of an LTE connection, and a fallback to a legacy radio access technology (RAT) and may cause interrupted service for the user.

### SUMMARY

Systems, methods, and apparatuses for reducing attach delay for a multi-subscriber information module (SIM) UE are described. A modem processor of a UE may receive a switch indication directing the modem to utilize a designated SIM, and the modem processor may access identification (ID) information from the SIM, including ID information for a network operator. The modem processor may then retrieve a stored access point name (APN) associated with the network operator and establish a connection to the data network identified by the stored APN. In some cases, the APN may be stored in the modem processor after a successful connection to the data network using the designated SIM. Additionally or alternatively, the UE may identify a network priority rule associated with the network operator of the SIM and establish the connection to the data network based on the priority rule.

A method of reducing attach delay for a multi-SIM UE is described. The method may include receiving a switch indication at a modem processor directing the modem processor to utilize a designated SIM, identifying an APN stored in the modem processor, the APN being associated with a network operator for the designated SIM, and establishing a connection to a data identified by the APN.

An apparatus for reducing attach delay for a multi-SIM UE is described. The apparatus may include means for receiving a switch indication at a modem processor directing the modem processor to utilize a designated SIM, means for identifying an APN stored in the modem processor, the APN being associated with a network operator for the designated SIM, and means for establishing a connection to a data network identified by the APN.

A further apparatus for reducing attach delay for a multi-SIM UE is described. The apparatus may include a processor, memory in electronic communication with the processor, and instructions stored in the memory. The instructions may be executable by the processor to receive a switch indication at a modem processor directing the modem processor to utilize a designated SIM, identify an APN stored in the modem processor, the APN being associated with a network operator for the designated SIM, and establish a connection to a data network identified by the APN.

A non-transitory computer-readable medium storing code for reducing attach delay for a multi-SIM UE is also described. The code may include instructions executable by a processor to receive a switch indication at a modem processor directing the modem processor to utilize a designated SIM, identify an APN stored in the modem processor, the APN being associated with a network operator for the designated SIM, and establish a connection to a data network identified by the APN.

Some examples of the method, apparatuses, and/or non-transitory computer-readable medium described above may further include features of, means for, and/or processor-executable instructions for retrieving a stored association between the APN and an ID of the designated SIM from the modem processor, in which the APN is identified based on the association between the APN and the ID. Additionally or alternatively, some examples may include features of, means for, and/or processor-executable instructions for establishing a prior connection to the data network associated with the APN, and storing the APN in the modem processor based at least in part on the prior connection.

Some examples of the method, apparatuses, and/or non-transitory computer-readable medium described above may further include features of, means for, and/or processor-executable instructions for may further include storing a first set of APNs comprising the APN in the modem processor, where each APN of the first set of APNs is associated with the network operator for the designated SIM. Additionally or alternatively, some examples may include features of, means for, and/or processor-executable instructions for storing a second set of APNs in the modem processor, where each APN of the second set of APNs is associated with a different network operator from the network operator for the designated SIM.

Some examples of the method, apparatuses, and/or non-transitory computer-readable medium described above may further include features of, means for, and/or processor-executable instructions for identifying a priority rule associated with the first set of APNs and the network operator for the designated SIM, where establishing the connection to the data network based at least in part on the priority rule. Some examples may include features of, means for, and/or processor-executable instructions for accessing identification information from the designated SIM, where the identification information comprises an identifier of the network operator.

Some examples of the method, apparatuses, and/or non-transitory computer-readable medium described above may further include features of, means for, and/or processor-executable instructions for sending the switch indication from an application processor of the UE. In some examples, the switch information comprises an instruction to switch from a prior SIM to the designated SIM.

In some examples of the method, apparatuses, and/or non-transitory computer-readable medium described above, the prior SIM is associated with a different network operator from the network operator of the designated SIM. In some examples, the APN is associated with an internet protocol (IP) network, an operator application network, an administrative network, or an internet protocol multimedia subsystem (IMS) network.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communications system for reducing attach delay for a multi-SIM user equipment (UE) in accordance with various aspects of the present disclosure;

FIG. 2 illustrates an example of a wireless communications system for reducing attach delay for a multi-SIM UE in accordance with various aspects of the present disclosure;

FIG. 3 illustrates an example of a process flow for reducing attach delay for a multi-SIM UE in accordance with various aspects of the present disclosure;

FIG. 4 illustrates an example of a process flow for reducing attach delay for a multi-SIM UE in accordance with various aspects of the present disclosure;

FIG. 5 shows a block diagram of a device for reducing attach delay for a multi-SIM UE in accordance with various aspects of the present disclosure;

FIG. 6 shows a block diagram of a device for reducing attach delay for a multi-SIM UE in accordance with various aspects of the present disclosure;

FIG. 7 shows a block diagram of a device for reducing attach delay for a multi-SIM UE in accordance with various aspects of the present disclosure;

FIG. 8 illustrates a block diagram of a system for reducing attach delay for a multi-SIM UE in accordance with various aspects of the present disclosure;

FIG. 9 shows a flowchart illustrating a method for reducing attach delay for a multi-SIM UE in accordance with various aspects of the present disclosure;

FIG. 10 shows a flowchart illustrating a method for reducing attach delay for a multi-SIM UE in accordance with various aspects of the present disclosure;

FIG. 11 shows a flowchart illustrating a method for reducing attach delay for a multi-SIM UE in accordance with various aspects of the present disclosure;

FIG. 12 shows a flowchart illustrating a method for reducing attach delay for a multi-SIM UE in accordance with various aspects of the present disclosure; and

FIG. 13 shows a flowchart illustrating a method for reducing attach delay for a multi-SIM UE in accordance with various aspects of the present disclosure.

### DETAILED DESCRIPTION

A modem processor of a UE may receive a switch indication directing the modem to utilize a designated SIM and may access identification (ID) information from the SIM including a network operator. The modem processor may then retrieve a stored access point name (APN) associated with the network operator and establish a connection to the data network identified by the stored APN. In some cases, the APN may be stored in the modem processor after a successful connection to the data network using the designated SIM. In some cases, the UE may also identify a network priority rule associated with the network operator of the SIM and establish the connection to the data network based on the priority rule.

Thus, by accessing the APN of the SIM from the modem processor, the UE may avoid a delay that may result from waiting for a message from the application processor indicating the appropriate APN. This may result in a faster transition to the new data network and may mitigate the interruption experienced by the user.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

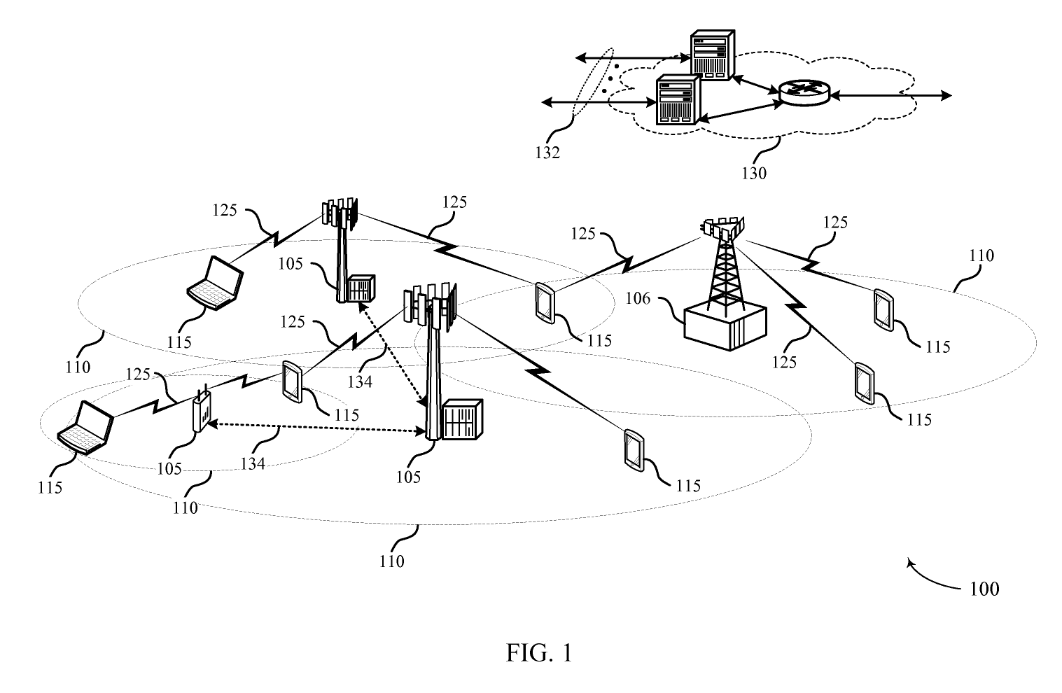

FIG. 1 illustrates an example of a wireless communications system 100 in accordance with various aspects of the present disclosure. The wireless communications system 100 includes base stations 105, at least one UE 115, and a core network 130. The core network 130 may provide user authentication, access authorization, tracking, internet protocol (IP) connectivity, and other access, routing, or mobility functions. The base stations 105 interface with the core network 130 through backhaul links 132 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors each making up a portion of the coverage area (not shown). The wireless communications system 100 may include base stations 105 of different types (e.g., macro and/or small cell base stations). There may be overlapping geographic coverage areas 110 for different technologies.

In some examples, the wireless communications system 100 is a Long Term Evolution (LTE)/LTE-. In LTE/LTE-s, the term evolved node B (eNB) may be generally used to describe the base stations 105, while the term UE may be generally used to describe the UEs 115. In some examples, wireless communications system 100 may also utilize legacy base stations 106, which may be based on a different radio access technology (RAT) than base stations 105. For example, base stations 105 may be LTE eNBs, whereas legacy base stations 106 may utilize 3rd or 2nd generation wireless technology (e.g., UMTS, GSM, CDMA, etc.). The wireless communications system 100 may also be a Heterogeneous LTE/LTE-A in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that accommodate some of the various disclosed examples may be packet-based networks that operate according to a layered protocol stack. In the user plane, communications at the bearer or packet data convergence protocol (PDCP) layer may be IP-based. A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARD) to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels.

The UEs 115 may be dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

In some embodiments of the wireless communications system 100, base stations 105 and/or UEs 115 may include multiple antennas for employing antenna diversity schemes to improve communication quality and reliability between base stations 105 and UEs 115. Additionally or alternatively, base stations 105 and/or UEs 115 may employ multiple input multiple output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

A UE 115 may store information regarding a subscriber identity associated with wireless communications system 100 on a subscriber information module (SIM). A subscriber information module (SIM) may be an integrated circuit that securely stores the international mobile subscriber identity (IMSI) and the related key used to identify and authenticate UE 115. The IMSI may also include an ID for the network operator of wireless communications system 100. The SIM may also contain a unique serial number (e.g., an integrated circuit card ID (ICCID)), security authentication and ciphering information, temporary information related to the local network, a list of the services, a personal identification number (PIN), and a personal unblocking code (PUK) for PIN unlocking In some cases, the SIM may be a circuit embedded in a removable plastic card.

A UE accessing a data network via wireless communications system 100 may designate an access point name (APN) of the data network. The APN may be the name of a gateway between wireless communications system 100 and another computer network (e.g., the Internet). A UE 115 making a data connection—as opposed to, e.g., a circuit switched voice connection—may be configured with an APN, which it may convey to the network upon obtaining a radio connection. A server of the core network 130 may then examine the APN to determine what type of network connection should be created—e.g., what IP or internet protocol multimedia subsystem (IMS) address should be assigned or what security methods should be used. In other words, the APN may identify the public data network (PDN) that a UE 115 wants to communicate with. In addition to identifying a PDN, an APN may also be used to define a service type—e.g., a wireless application protocol (WAP) server or multimedia messaging service (MMS)—that is provided by the PDN.

According to the present disclosure, a modem processor of a UE 115 may receive a switch indication directing the modem to utilize a designated SIM and access ID information including a network operator of wireless communications system 100. The modem processor may then retrieve an APN associated with the network operator and establish a connection to the data network identified by the stored APN. In some cases, the APN may be stored in the modem processor after a successful connection to the data network using the designated SIM. In some cases, the UE 115 may also identify a network priority rule associated with the network operator of the SIM and establish the connection to the data network based on the priority rule.

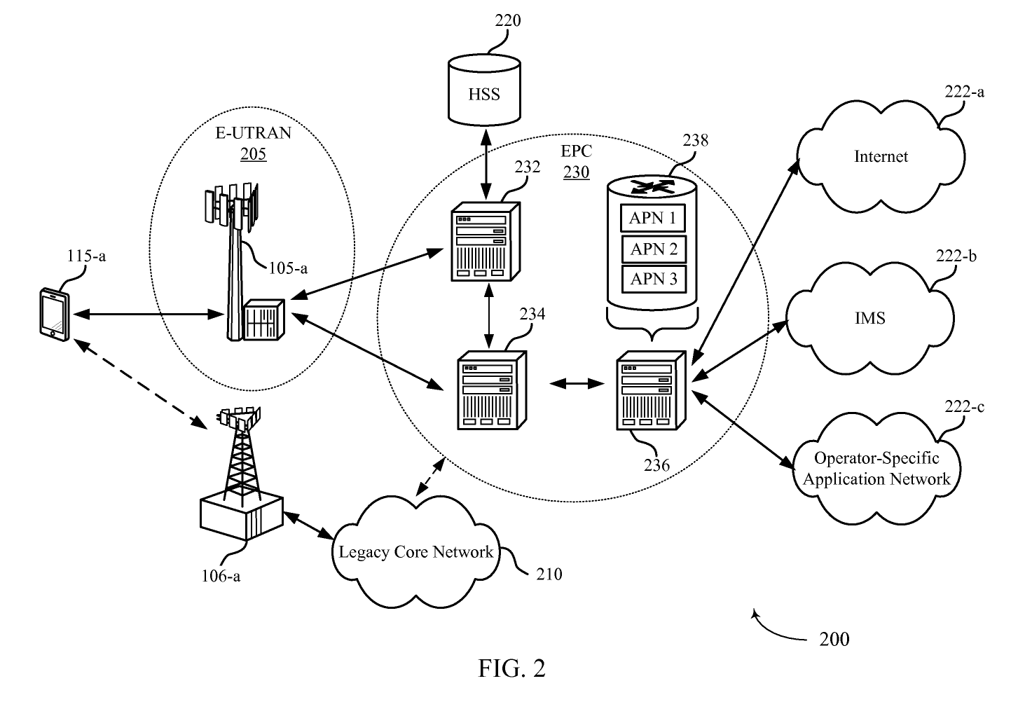

FIG. 2 illustrates an example of a wireless communications system 200 for reducing attach delay for a multi-SIM UE in accordance with various aspects of the present disclosure. Wireless communications system 200 illustrate aspects of the wireless communications system 100 of FIG. 1. For instance, wireless communications system 200 may be an example of an LTE network, and may include a UE 115-a, a base station 105-a, and a legacy base station 106-a, which may be examples of the corresponding devices described above with reference to FIG. 1. Base station 105-a may be one of multiple base stations 105 that form an evolved universal mobile telecommunications system (UMTS) terrestrial radio access network (E-UTRAN) 205.

E-UTRAN 205 may be connected—e.g., by an S1 interface—to evolved packet core (EPC) 230, which may be an example of a core network 130, as described above with reference to FIG. 1. EPC 230 may include a mobility management entity (MME) 232, one or more serving gateways (S-GW) 234, and one or more packet data network (PDN) gateways (P-GW) 236. MME 232 may be the control node that processes the signaling between the UE 115-a and the EPC 230, and may be connected to a home subscriber service 220. All user IP packets may be transferred through the S-GW 234, which itself may be connected to P-GW 236. P-GW 236 may provide IP address allocation and connect UE 115-a to a PDN. P-GW 236 may also be connected to the network operator's IP services. The operator's IP services may include the Internet 222-a, an Intranet (not shown), and operator-specific application network 222-c, an IP Multimedia Subsystem (IMS) 222-b, a Packet-Switched (PS) Streaming Service (PSS) (not shown), as well as other network services. P-GW 236 may contain a database 238 including one or more APNs, which may be associated with the different PDNs and network services connected to P-GW 236.

In some cases, wireless communications system 200 may also include a legacy base station 106-a, which may be connected to a legacy core network 210. For example, legacy core network 210 may support fallback 3G communication services if UE 115-a does not establish an LTE IP connection.

According to the present disclosure, a modem processor of a UE 115-a may receive a switch indication directing the modem to utilize a designated SIM and access ID information including a network operator of wireless communications system 200. The modem processor may then retrieve an APN associated with the network operator and establish a connection to the data network identified by the stored APN—e.g., an APN for connecting to the internet 222-a. In some cases, the APN may be stored in the modem processor after a successful connection to the data network using the designated SIM. Additionally or alternatively, UE 115-a may identify a network priority rule associated with the network operator of the SIM and establish the connection to the data network based on the priority rule.

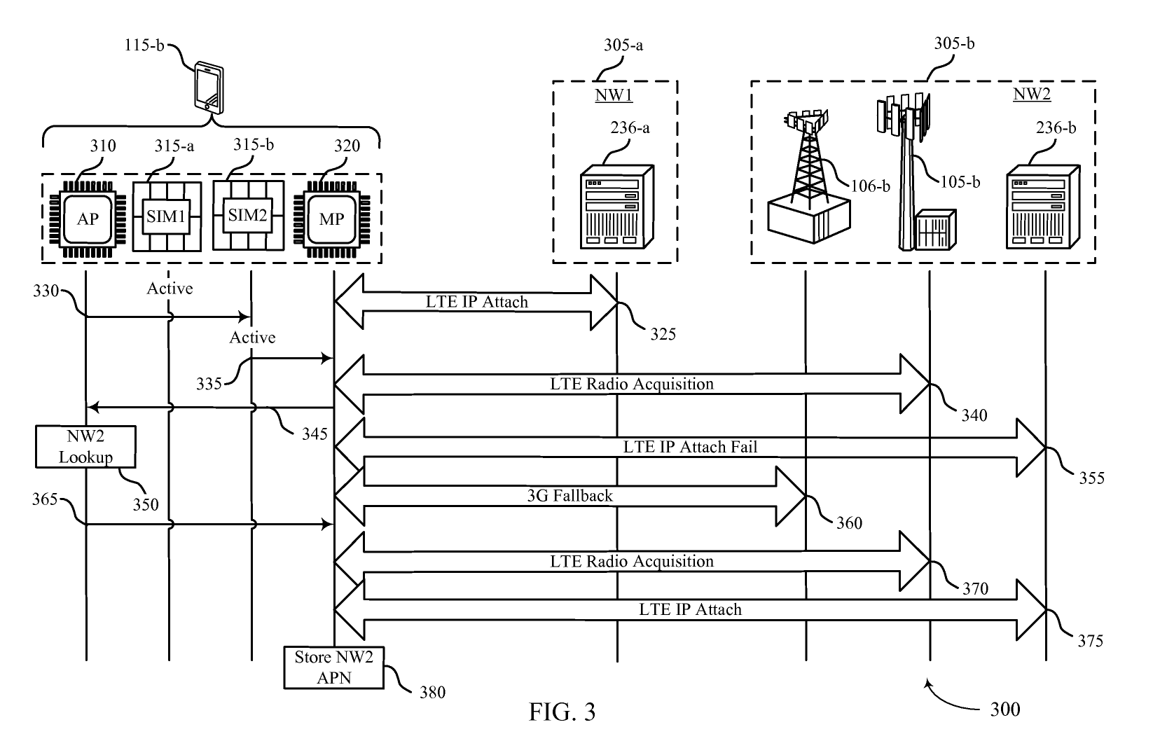

FIG. 3 illustrates an example of a process flow 300 for reducing attach delay for a multi-SIM UE in accordance with various aspects of the present disclosure. Specifically, process flow 300 may illustrate one method of storing an APN in a modem processor. Process flow 300 may include a UE 115-b, which may be an example of a UE 115 described above with reference to FIGS. 1 and 2. UE 115-b may include application processor (AP) 310, a first SIM (SIM1) 315-a, a second SIM (SIM2) 315-b, and a modem processor (MP) 320. Process flow 300 may also include a first network 305-a, which may include P-GW 236-a. Process flow 300 may also include a second network 305-b, which may include a legacy base station 106-b, base station 105-b, and P-GW 236-b, which may be examples of components described above with reference to FIGS. 1 and 2.

Prior to the steps depicted by process flow 300, UE 115-b may establish a radio connection with the first network 305-a using SIM1 315-a, which may enable UE 115-b at step 325 to exchange packet data via P-GW 236-a. At step 330, however, AP 310 may activate SIM2, which at step 335 may pass ID and security information to MP 320. For example, MP 320 may obtain an IMSI from SIM2 315-b, which may include an identifier for the network operator associated with second network 305-b.

At step 340, UE 115-a (via MP 320) may establish a radio connection to the second network 305-b via base station 105-c based on the information obtained from SIM2 315-b. In some cases, an APN is passed to second network 305-b during LTE radio acquisition, step 340. However, MP 320 may not have an updated APN for second network 305-b, so it may pass an APN associated with first network 305-a.

At step 345, MP 320 may pass the radio connection information from second network 305-b to AP 310. For example, MP 320 may pass information associated with second network 305-b such as a mobile country code (MCC) and mobile network code (MNC). Then, at step 350, AP 310 may look up the APN associated with the second network 305-b and at step 365, AP 310 may pass the updated APN to MP 320. But prior to receiving the updated APN at step 365, at step 355 UE 115-b may fail to attach to a data network via second network 305-b because, for instance, the attempt was made using the APN associated with first network 305-a.

At step 360, due to the failure to attach to the data network, in some cases UE 115-b may fall back to communicating via legacy base station 106-b associated with the second network 305-b. This may result in an interruption of service for UE 115-b. For example, second network 305-b and MP 320 may initiate data throttling logic based on the failure to attach to the data network. That is, since the legacy fallback for second network 305-b may not have the same capabilities as the primary data network option, the user may experience a reduced data rate or even connection failure.

At step 370, after passing the updated APN from AP 310 to MP 320, UE 115-b may again attempt to establish a radio connection via base station 105-c. Based on the updated APN, UE 115-b may, at step 375, successfully establish a connection to a data network via P-GW 236-b. At step 380, after determining that a successful data connection has been established with second network 305-b, UE 115-b may store the APN in MP 320 based at least in part on the connection and associate it with second network 305-b and/or SIM2 315-b. This may enable UE 115-b to access a data network via second network 305-b the next time—e.g., during a subsequent attach procedure—without the delay associated with using the APN associated with first network 305-a. MP 320 may also store other information associated with the network in addition to the APN.

In some cases, UE 115-b may store a set of APNs associated with the network operator of second network 305-b (and/or with SIM2 315-b). The UE 115 may also store another set of APNs in MP 320 associated with a different network operator (e.g., for first network 305-a and/or SIM1 315-a).

Thus, the APN associated with second network 305-b may be stored in MP 320 after a successful connection to the data network using SIM2 315-b. After which, MP 320 may receive a switch indication from AP 310 directing MP 320 to utilize SIM2 315-b and may access ID information from the SIM2 315-b including a network operator ID. MP 320 may then retrieve the stored APN associated with second network 305-b and establish a connection to the data network identified by the stored APN.

The steps of process flow 300 illustrate one example of a process for storing an APN in MP 320 of UE 115-b. Other methods are also possible. For example, AP 310 may pass a table associating a set of network operators with APNs to MP 320.

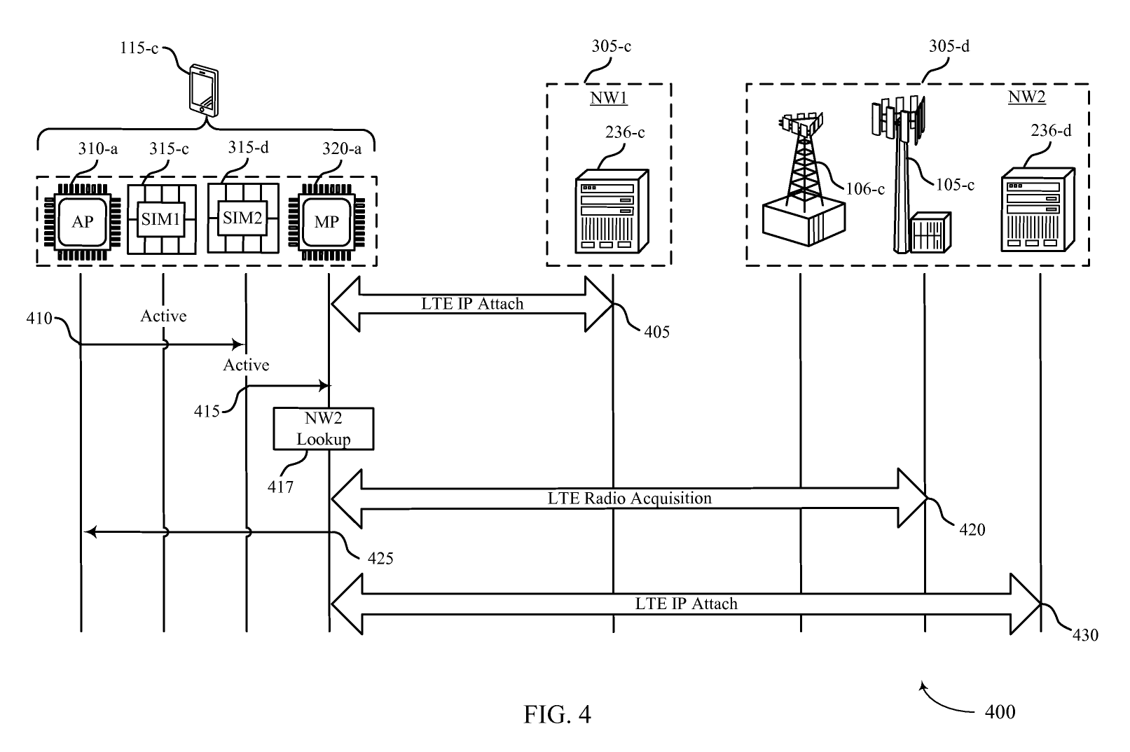

FIG. 4 illustrates an example of a process flow 400 for reducing attach delay for a multi-SIM UE in accordance with various aspects of the present disclosure. Specifically, process flow 400 may illustrate one method of retrieving an APN from a modem processor. Process flow 400 may include a UE 115-c, which may be an example of a UE 115 described above with reference to FIGS. 1-3. UE 115-c may include AP 310-a, SIM1 315-c, SIM2 315-d, and MP 320-a. Process flow 400 may also include a first network 305-c, which may include P-GW 236-c. Process flow 400 may also include a second network 305-d, which may include a legacy base station 106-c, base station 105-c, and P-GW 236-d, which may be examples of components described above with reference to FIGS. 1-3. In some cases, the steps of process flow 400 may occur after MP 320-a has stored an APN for second network 305-d, as described above with reference to FIG. 3.

Prior to the steps depicted by process flow 400, UE 115-c may establish a radio connection with the first network 305-c using SIM1 315-c, which may enable UE 115-c at step 405 to exchange packet data via P-GW 236-c. At step 410, however, AP 310-a may activate SIM2 315-d, which at step 415 may pass ID and security information to MP 320-a. For example, MP 320-a may obtain an IMSI from SIM2 315-d, which may include an identifier for the network operator associated with second network 305-d. Thus, UE 115-c may receive a switch indication at MP 320-a directing the MP 320-a to utilize SIM2 315-d.

At step 417, MP 320-a may look up an APN for the second network 305-d. In some examples the APN may be associated with an IP network, an operator application network, an administrative network, or an IMS network. Thus, UE 115-c may identify an APN stored in MP 320-a associated with a network operator for SIM2 315-d. In some cases, UE 115-c may retrieve a stored association between the APN and an ID of the designated SIM (e.g., a universal integrate circuit card (UICC) ID) such that the APN may be identified based on the mapping between the APN and the ID.

At step 420, UE 115-c may establish a radio connection with the second network 305-d (e.g., via MP 320-a and base station 105-d). In some cases, at step 425, MP 320-a may pass the network identification information back to AP 310. However, MP 320-a may already have the stored APN, so UE 115-c may, at step 430, successfully establish a data network connection with second network 305-d (e.g., via P-GW 236-d) without waiting for AP 310-a to pass the updated APN to MP 320-a. Thus, UE 115-c may establish a connection to a data network associated with second network 305-d based on the identified APN stored in MP 320-a. In some cases, MP 320-a may also identify a priority rule associated with the stored APN and/or the network operator for SIM2 315-d and establish the connection to the data network based at least in part on the priority rule.

Thus, MP 320-a may receive a switch indication directing MP 320-a to utilize SIM2 315-d and access ID information including, e.g., information for an operator of network 305-d. MP 320-a may then retrieve an APN associated with the network operator and establish a connection to the data network identified by the stored APN. In some cases, the APN may be stored in the modem processor after a successful connection to the data network using SIM2 315-d, as described above with reference to FIG. 3. In some cases, MP 320-a may also identify a network priority rule associated with the network operator of the SIM and establish the connection to the data network based on the priority rule.

Those skilled in the art will recognize the benefits of procedure of process flow 400, as applied to an LTE/LTE-A network, among others. LTE/LTE-A networks may, for instance, implement an “always-on” IP connectivity from a time a UE 115 attaches to a network; this may be unlike some 3G/2G technologies (e.g., UMTS, GSM, etc.) in which a PS domain attach may not mean an IP attach. Additionally, data roaming utilizing LTE/LTE-A systems may be susceptible to undesirable delays when 3G fall back occurs; thus avoiding such delay may be important for user experience under a 4G roaming scenario. Additionally, modern smartphones, and other UEs, may be equipped with provisioning software on an AP, which may readily allow for modem (e.g., MP) configuration to implement attach-delay avoidance techniques described herein.

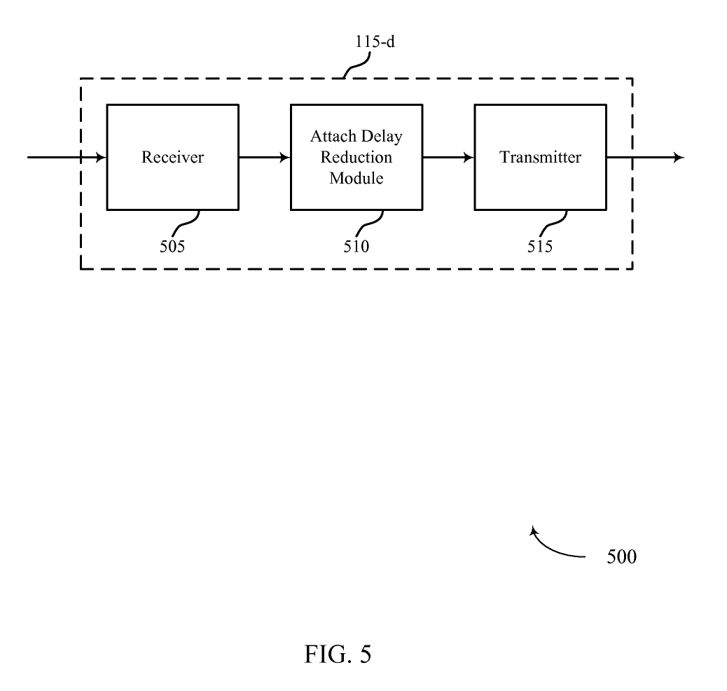

FIG. 5 shows a block diagram 500 of a UE 115-d for reducing attach delay for a multi-SIM UE in accordance with various aspects of the present disclosure. UE 115-d may be an example of aspects of a UE 115 described with reference to FIGS. 1-4. UE 115-d may include a receiver 505, an attach delay reduction module 510, and/or a transmitter 515. The UE 115-d may also include a processor. Each of these components may be in communication with one another.

The components of the UE 115-d may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 505 may receive information such as packets, user data, and/or control information associated with various information channels (e.g., control channels, data channels, and information related to reducing attach delay for a multi-SIM UE, etc.). Information may be passed on to the attach delay reduction module 510, and to other components of UE 115-d.

The attach delay reduction module 510 may receive a switch indication at a modem processor directing the modem processor to utilize a designated SIM, identify an APN stored in the modem processor (the APN being associated with a network operator for the designated SIM), and establish a connection to a data network identified by the APN. In some cases, attach delay reduction module 510 may be a component of a modem processor.

The transmitter 515 may transmit signals received from other components of UE 115-d. In some embodiments, the transmitter 515 may be collocated with the receiver 505 in a transceiver module. The transmitter 515 may include a single antenna, or it may include a plurality of antennas.

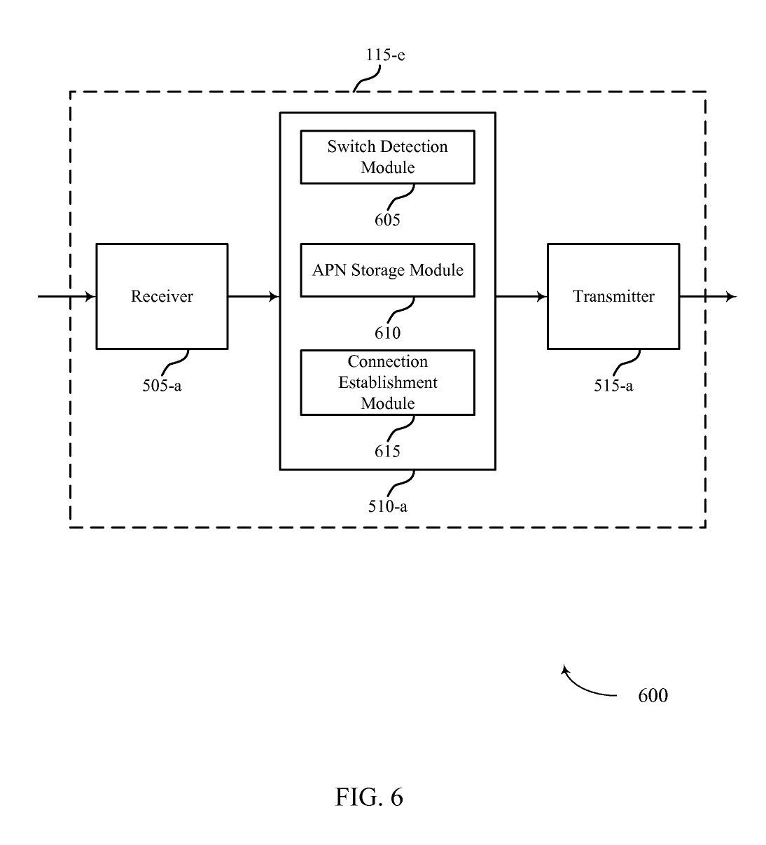

FIG. 6 shows a block diagram 600 of a UE 115-e for reducing attach delay for a multi-SIM UE in accordance with various aspects of the present disclosure. The UE 115-e may be an example of aspects of a UE 115 described with reference to FIGS. 1-5. The UE 115-e may include a receiver 505-a, an attach delay reduction module 510-a, and/or a transmitter 515-a. The UE 115-e may also include a processor. Each of these components may be in communication with one another. The attach delay reduction module 510-a may also include a switch detection module 605, an APN storage module 610, and a connection establishment module 615.

The components of the UE 115-e may, individually or collectively, be implemented with at least one ASIC adapted to perform some or all of the applicable functions in hardware. Alternatively, the functions may be performed by other processing units (or cores), on an IC or ICs. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 505-a may receive information which may be passed on to the attach delay reduction module 510-a, and to other components of the UE 115-e. The attach delay reduction module 510-a may perform the operations described above with reference to FIG. 5. The transmitter 515-a may transmit signals received from other components of the UE 115-e.

The switch detection module 605 may receive a switch indication at a modem processor directing the modem processor to utilize a designated SIM, as described above with reference to FIGS. 2-4. In some examples, the switch information includes an instruction to switch from a prior SIM to the designated SIM. In some examples, the prior SIM may be associated with a different network operator from the network operator of the designated SIM.

The APN storage module 610 may identify an APN stored in the modem processor, where the APN may be associated with a network operator for the designated SIM, as described above with reference to FIGS. 2-4. The APN storage module 610 may also store the APN in the modem processor based at least in part on the prior connection, and retrieve a stored association between the APN and an ID of the designated SIM, as described above with reference to FIGS. 2-4. The APN storage module 610 may also store (e.g., in the memory of the modem processor) a first set of APNs associated with the network operator for the designated SIM and a second set of APNs associated with a different network operator, as described above with reference to FIGS. 2-4. In some examples, the APN may be associated with an IP network, an operator application network, an administrative network, or an IMS network.

The connection establishment module 615 may establish a connection to a data network identified by the APN, as described above with reference to FIGS. 2-4.

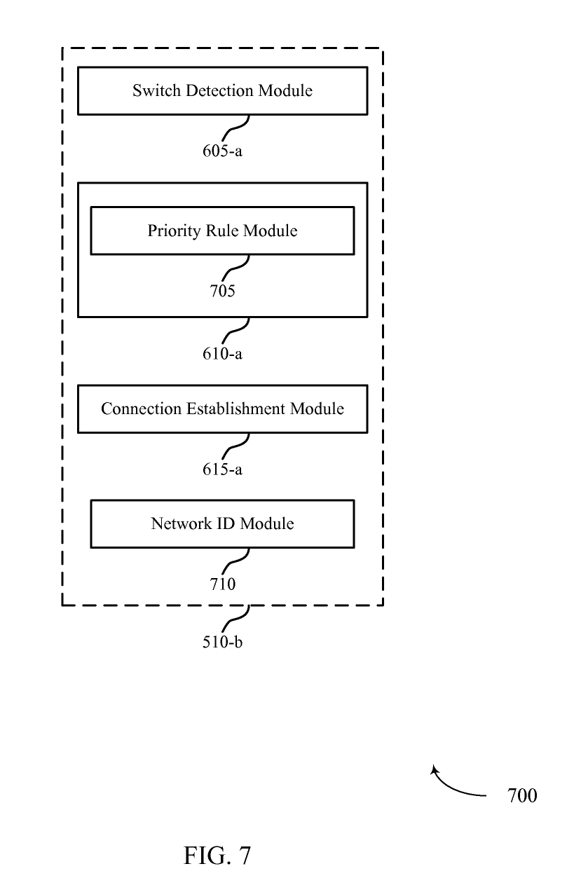

FIG. 7 shows a block diagram 700 of an attach delay reduction module 510-b for reducing attach delay for a multi-SIM UE in accordance with various aspects of the present disclosure. The attach delay reduction module 510-b may be an example of aspects of an attach delay reduction module 510 described with reference to FIGS. 5-6. The attach delay reduction module 510-b may include a switch detection module 605-a, an APN storage module 610-a, and a connection establishment module 615-a. Each of these modules may perform the functions described above with reference to FIG. 6, and each may be in communication with one another. The attach delay reduction module 510-b may also include a priority rule module 705, and ID module 710.

The components of the attach delay reduction module 510-b may, individually or collectively, be implemented with at least one ASIC adapted to perform some or all of the applicable functions in hardware. Alternatively, the functions may be performed by other processing units (or cores), one or more ICs. In other embodiments, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The priority rule module 705 may identify a priority rule associated with the first set of APNs and the network operator for the designated SIM, thus establishing the connection to the data network based on the priority rule, as described above with reference to FIGS. 2-4.

The network ID module 710 may access identification information from the designated SIM, where the identification information comprises an identifier of the network operator, as described above with reference to FIGS. 2-4.

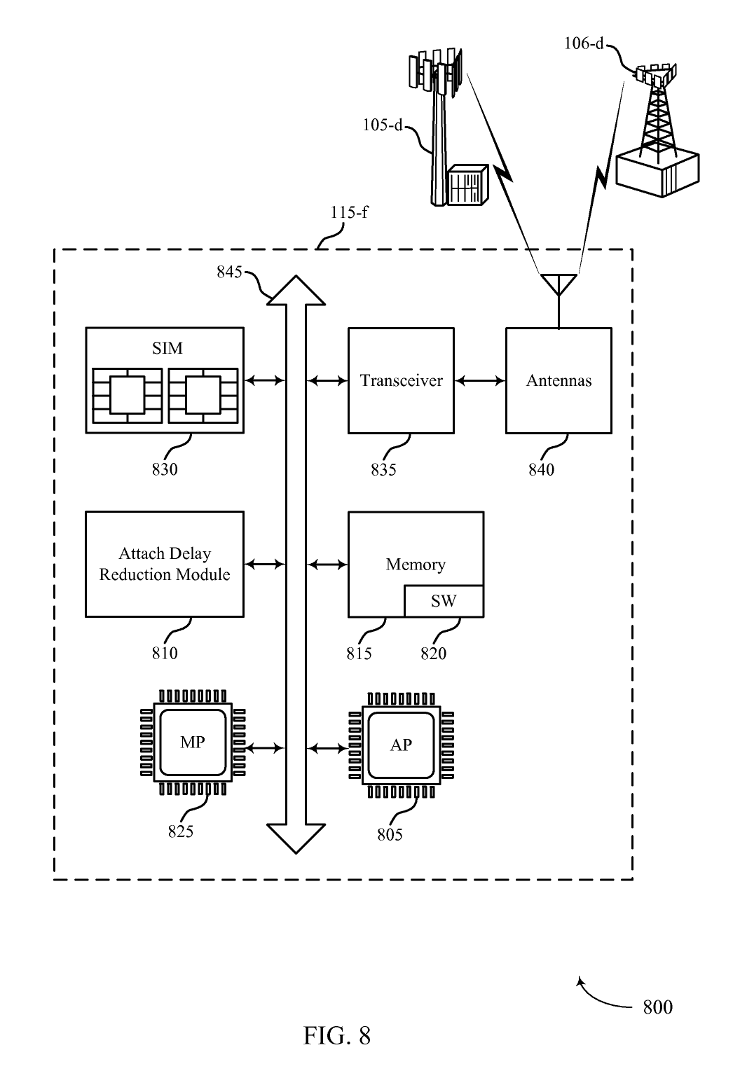

FIG. 8 shows a diagram of a system 800 for reducing attach delay for a multi-SIM UE in accordance with various aspects of the present disclosure. System 800 may include a UE 115-f, which may be an example of an UE 115 described above with reference to FIGS. 1-7. The UE 115-f may include an attach delay reduction module 810, which may be an example of an attach delay reduction module 510 described with reference to FIGS. 5-7. The UE 115-f may also include components for bi-directional voice and data communications including components for transmitting communications and components for receiving communications. For example, the UE 115-f may communicate bi-directionally with legacy base station 106-d and/or a base station 105-d. UE 115-f may also include an AP 805, MP 825 and SIM 830.

AP 805 may be an example of an AP 310 described above with reference to FIGS. 3-4. For example, AP 805 may send the switch indication directing MP 825 to utilize a different SIM as described above with reference to FIGS. 2-4. UE 115-f may also include memory 815 (including software (SW) 820), a transceiver module 835, and one or more antenna(s) 840, which each may communicate, directly or indirectly, with each other (e.g., via buses 845).

The memory 815 may include random access memory (RAM) and read only memory (ROM). The memory 815 may store computer-readable, computer-executable software/firmware code 820 including instructions that, when executed, cause the AP 805 to perform various functions described herein (e.g., reducing attach delay for a multi-SIM UE, etc.). Alternatively, the software/firmware code 820 may not be directly executable by the AP 805 but cause a computer (e.g., when compiled and executed) to perform functions described herein. The AP 805 may include an intelligent hardware device, e.g., a central processing unit (CPU), a microcontroller, an ASIC, etc.

SIM 830 may include one or more SIM cards as described above with reference to FIGS. 1-4 (e.g., SIMs 315 described with reference to FIGS. 3-4). In some cases, SIM 830 may include multiple SIM identities included in a single physical card. In some cases, SIM 830 may include multiple cards. In other cases, SIM 830 may include several logical SIM cards that reside on common hardware.

In some cases, transceiver module 835 may include or be collocated with the MP 825 and/or the attach delay reduction module 810. The transceiver module 835 may communicate bi-directionally, via the antenna(s) 840 and/or wired or wireless links, with one or more networks, as described above. For example, the transceiver module 835 may communicate bi-directionally with a base station 105 and/or another UE 115. In some cases, the transceiver module 835 may include the MP 825, which may modulate the packets and provide the modulated packets to the antenna(s) 840 for transmission, and to demodulate packets received from the antenna(s) 840. While the UE 115-f may include a single antenna 840, the UE 115-f may also have multiple antennas 840 capable of concurrently transmitting and/or receiving multiple wireless transmissions.

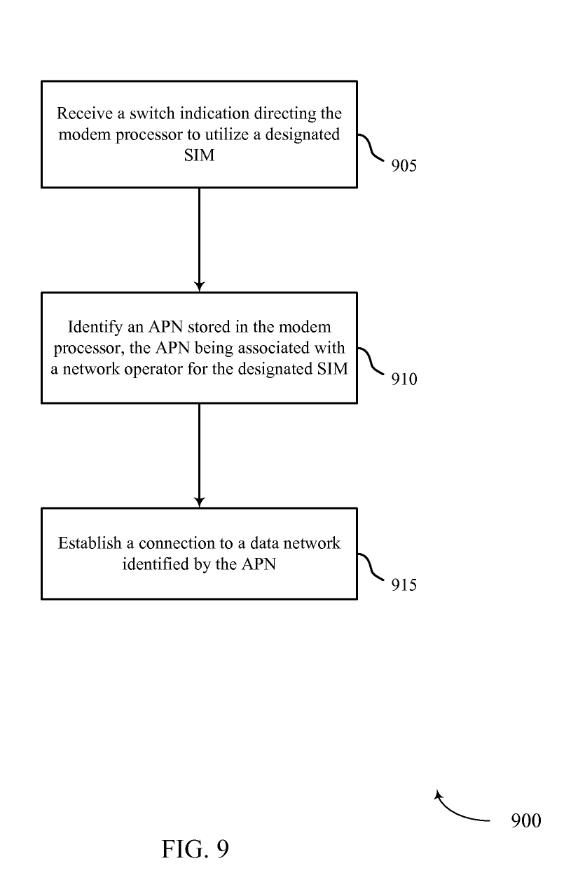

FIG. 9 shows a flowchart illustrating a method 900 for reducing attach delay for a multi-SIM UE in accordance with various aspects of the present disclosure. The operations of method 900 may be implemented by a UE 115 or its components as described with reference to FIGS. 1-8. In certain examples, the operations of method 900 may be performed by the attach delay reduction module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware.

At block 905, the UE 115 may receive a switch indication at a modem processor directing the modem processor to utilize a designated SIM, as described above with reference to FIGS. 2-4. In certain examples, the operations of block 905 may be performed by the switch detection module 605, as described above with reference to FIG. 6.

At block 910, the UE 115 may identify an APN stored in the modem processor, the APN being associated with a network operator for the designated SIM as described above with reference to FIGS. 2-4. In certain examples, the operations of block 910 may be performed by the APN storage module 610, as described above with reference to FIG. 6.

At block 915, the UE 115 may establish a connection to a data network identified by the APN as described above with reference to FIGS. 2-4. In certain examples, the operations of block 915 may be performed by the connection establishment module 615, as described above with reference to FIG. 6.

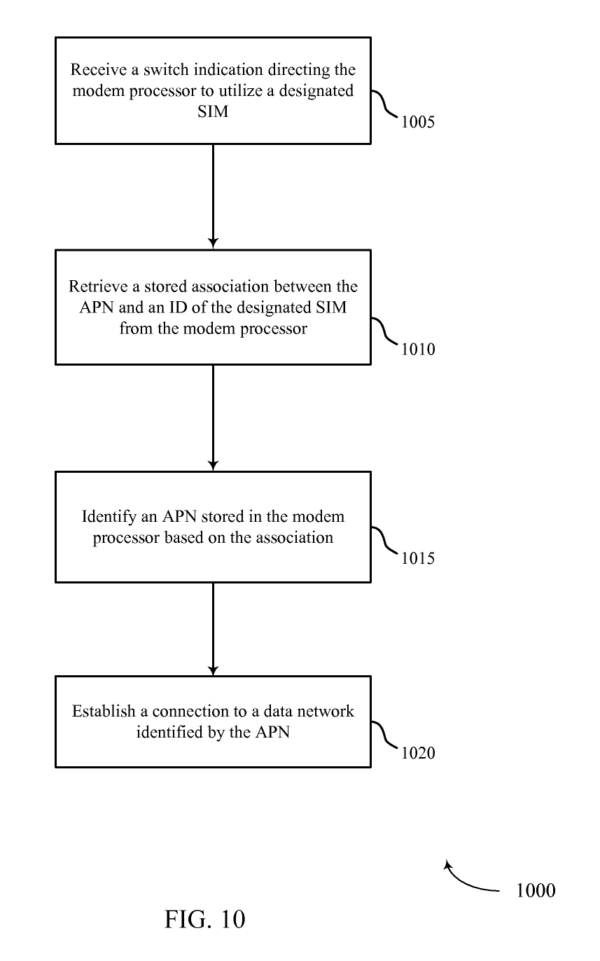

FIG. 10 shows a flowchart illustrating a method 1000 for reducing attach delay for a multi-SIM UE in accordance with various aspects of the present disclosure. The operations of method 1000 may be implemented by a UE 115 or its components, as described with reference to FIGS. 1-8. In certain examples, the operations of method 1000 may be performed by the attach delay reduction module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1000 may also incorporate aspects of method 900 of FIG. 9.

At block 1005, the UE 115 may receive a switch indication at a modem processor directing the modem processor to utilize a designated SIM, as described above with reference to FIGS. 2-4. In certain examples, the operations of block 1005 may be performed by the switch detection module 605, as described above with reference to FIG. 6.

At block 1010, the UE 115 may retrieve a stored association between the APN and an ID of the designated SIM from the modem processor, where the APN is identified based on the association between the APN and the ID, as described above with reference to FIGS. 2-4. In certain examples, the operations of block 1010 may be performed by the APN storage module 610, as described above with reference to FIG. 6.

At block 1015, the UE 115 may identify an APN stored in the modem processor, the APN being associated with a network operator for the designated SIM, as described above with reference to FIGS. 2-4. In certain examples, the operations of block 1015 may be performed by the APN storage module 610, as described above with reference to FIG. 6.

At block 1020, the UE 115 may establish a connection to a data network identified by the APN, as described above with reference to FIGS. 2-4. In certain examples, the operations of block 1020 may be performed by the connection establishment module 615, as described above with reference to FIG. 6.

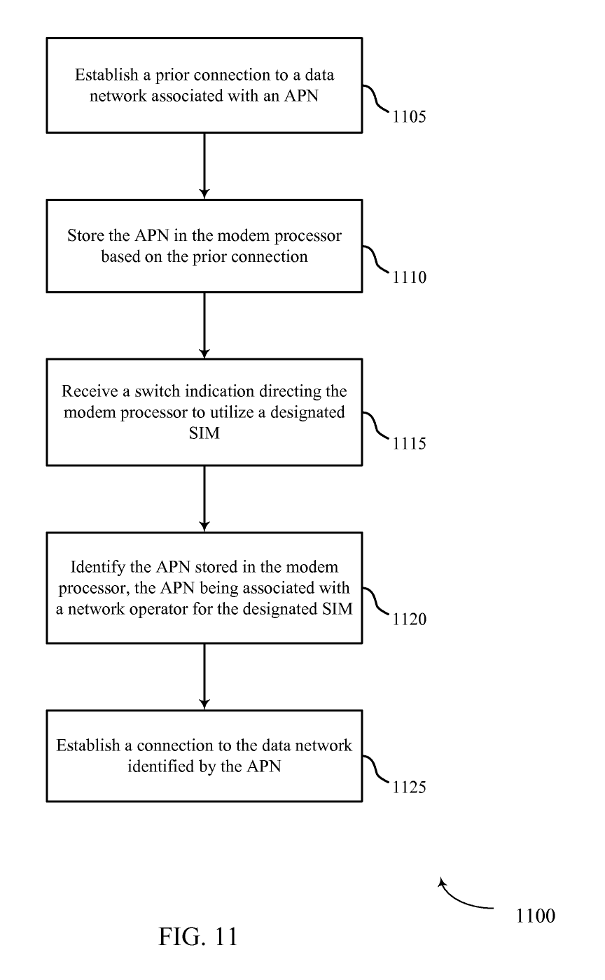

FIG. 11 shows a flowchart illustrating a method 1100 for reducing attach delay for a multi-SIM UE in accordance with various aspects of the present disclosure. The operations of method 1100 may be implemented by a UE 115 or its components, as described with reference to FIGS. 1-8. In certain examples, the operations of method 1100 may be performed by the attach delay reduction module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1100 may also incorporate aspects of methods 900 and 1000 of FIGS. 9-10.

At block 1105, the UE 115 may establish a prior connection to the data network associated with the APN as described above with reference to FIGS. 2-4. In certain examples, the operations of block 1105 may be performed by the connection establishment module 615, as described above with reference to FIG. 6.

At block 1110, the UE 115 may store an APN (and in some cases, an association with the ID of a SIM) in a modem processor based at least in part on the prior connection, as described above with reference to FIGS. 2-4. In certain examples, the operations of block 1110 may be performed by the APN storage module 610, as described above with reference to FIG. 6.

At block 1115, the UE 115 may receive a switch indication at the modem processor directing the modem processor to utilize a designated SIM, as described above with reference to FIGS. 2-4. In certain examples, the operations of block 1115 may be performed by the switch detection module 605, as described above with reference to FIG. 6.

At block 1120, the UE 115 may identify the APN stored in the modem processor, the APN being associated with a network operator for the designated SIM (and in some cases, the ID of the designated SIM), as described above with reference to FIGS. 2-4. In certain examples, the operations of block 1120 may be performed by the APN storage module 610, as described above with reference to FIG. 6.

At block 1125, the UE 115 may establish a connection to a data network identified by the APN, as described above with reference to FIGS. 2-4. In certain examples, the operations of block 1125 may be performed by the connection establishment module 615, as described above with reference to FIG. 6.

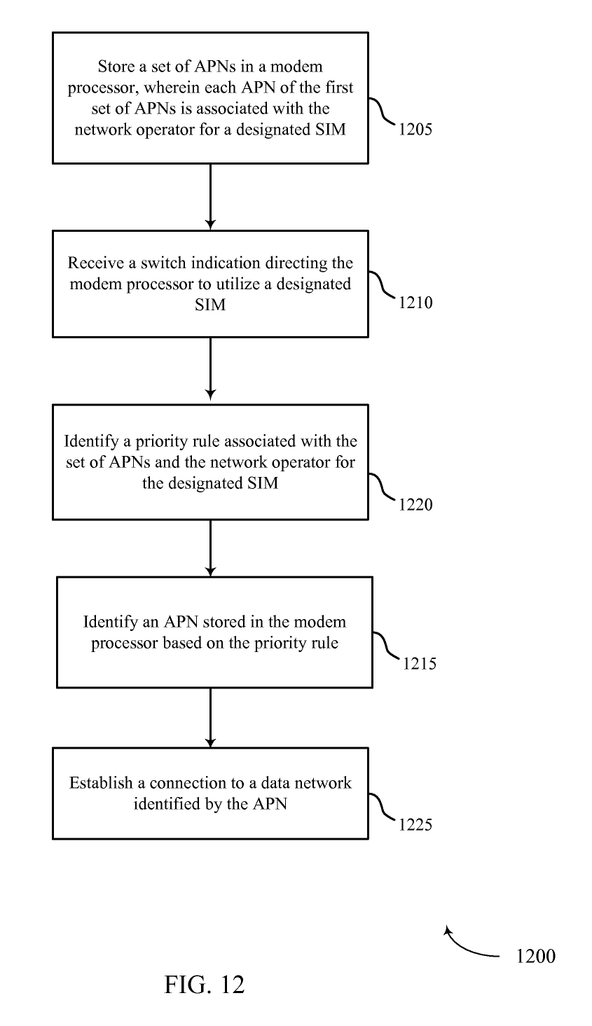

FIG. 12 shows a flowchart illustrating a method 1200 for reducing attach delay for a multi-SIM UE in accordance with various aspects of the present disclosure. The operations of method 1200 may be implemented by a UE 115 or its components, as described with reference to FIGS. 1-8. In certain examples, the operations of method 1200 may be performed by the attach delay reduction module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1200 may also incorporate aspects of methods 900, 1000, and 1100 of FIGS. 9-11.

At block 1205, the UE 115 may store a first set of APNs including an APN in a modem processor, where each APN of the first set of APNs is associated with the network operator for the designated SIM, as described above with reference to FIGS. 2-4. In certain examples, the operations of block 1205 may be performed by the APN storage module 610, as described above with reference to FIG. 6.

At block 1210, the UE 115 may receive a switch indication at the modem processor directing the modem processor to utilize a designated SIM, as described above with reference to FIGS. 2-4. In certain examples, the operations of block 1205 may be performed by the switch detection module 605, as described above with reference to FIG. 6.

At block 1215, the UE 115 may identify a priority rule associated with the first set of APNs and the network operator for the designated SIM, where establishing the (subsequent) connection to the data network based at least in part on the priority rule, as described above with reference to FIGS. 2-4. In certain examples, the operations of block 1215 may be performed by the priority rule module 705, as described above with reference to FIG. 7.

At block 1220, the UE 115 may identify the APN (e.g., from the first set of APNs) stored in the modem processor (e.g., based on the priority rule), the APN being associated with a network operator for the designated SIM, as described above with reference to FIGS. 2-4. In certain examples, the operations of block 1215 may be performed by the APN storage module 610, as described above with reference to FIG. 6.

At block 1225, the UE 115 may establish a connection to a data network identified by the APN, as described above with reference to FIGS. 2-4. In certain examples, the operations of block 1225 may be performed by the connection establishment module 615, as described above with reference to FIG. 6.

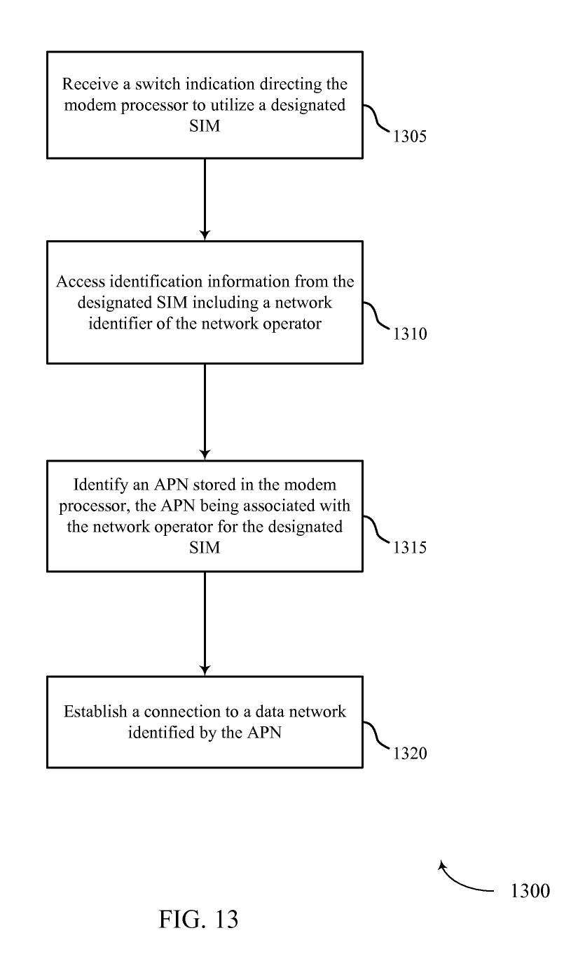

FIG. 13 shows a flowchart illustrating a method 1300 for reducing attach delay for a multi-SIM UE in accordance with various aspects of the present disclosure. The operations of method 1300 may be implemented by a UE 115 or its components, as described with reference to FIGS. 1-8. In certain examples, the operations of method 1300 may be performed by the attach delay reduction module 510, as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1300 may also incorporate aspects of methods 900, 1000, 1100, and 1200 of FIGS. 9-12.

At block 1305, the UE 115 may receive a switch indication at a modem processor directing the modem processor to utilize a designated SIM, as described above with reference to FIGS. 2-4. In certain examples, the operations of block 1305 may be performed by the switch detection module 605, as described above with reference to FIG. 6.

At block 1310, the UE 115 may access identification information from the designated SIM, where the identification information includes an identifier of the network operator, as described above with reference to FIGS. 2-4. In certain examples, the operations of block 1310 may be performed by the network ID module 710, as described above with reference to FIG. 7.

At block 1315, the UE 115 may identify an APN stored in the modem processor, the APN being associated with a network operator for the designated SIM, as described above with reference to FIGS. 2-4. In certain examples, the operations of block 1315 may be performed by the APN storage module 610, as described above with reference to FIG. 6.

At block 1320, the UE 115 may establish a connection to a data network identified by the APN, as described above with reference to FIGS. 2-4. In certain examples, the operations of block 1320 may be performed by the connection establishment module 615, as described above with reference to FIG. 6.

Thus, methods 900, 1000, 1100, 1200, and 1300 may provide for reducing attach delay for a multi-SIM UE. It should be noted that methods 900, 1000, 1100, 1200, and 1300 describe possible implementation, and that the operations and the steps may be rearranged or otherwise modified such that other implementations are possible. In some examples, aspects from two or more of the methods 900, 1000, 1100, 1200, and 1300 may be combined.

The detailed description set forth above in connection with the appended drawings describes exemplary embodiments and does not represent all the embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.)

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or ” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile

Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of reducing attach delay for a multi-SIM user equipment (UE), comprising:
receiving a switch indication at a modem processor directing the modem processor to utilize a designated subscriber information module (SIM);
identifying an access point name (APN) stored in the modem processor, the APN being associated with a network operator for the designated SIM; and
establishing a connection to a data network identified by the APN.

2. The method of claim 1, further comprising:
retrieving a stored association between the APN and an identification (ID) of the designated SIM from the modem processor, wherein the APN is identified based on the association between the APN and the ID.

3. The method of claim 1, further comprising:
establishing a prior connection to the data network associated with the APN; and
storing the APN in the modem processor based at least in part on the prior connection.

4. The method of claim 1, further comprising:
storing a first set of APNs comprising the APN in the modem processor, wherein each APN of the first set of APNs is associated with the network operator for the designated SIM.

5. The method of claim 4, further comprising:
storing a second set of APNs in the modem processor, wherein each APN of the second set of APNs is associated with a different network operator from the network operator for the designated SIM.

6. The method of claim 4, further comprising:
identifying a priority rule associated with the first set of APNs and the network operator for the designated SIM, wherein establishing the connection to the data network based at least in part on the priority rule.

7. The method of claim 1, further comprising:
accessing identification information from the designated SIM, wherein the identification information comprises an identifier of the network operator.

8. The method of claim 1, further comprising:
sending the switch indication from an application processor of the UE.

9. The method of claim 1, wherein the switch indication comprises an instruction to switch from a prior SIM to the designated SIM.

10. The method of claim 9, wherein the prior SIM is associated with a different network operator from the network operator for the designated SIM.

11. The method of claim 1, wherein the APN is associated with an internet protocol (IP) network, an operator application network, an administrative network, or an internet protocol multimedia subsystem (IMS) network.

12. An apparatus for reducing attach delay for a multi-SIM user equipment (UE), comprising:
means for receiving a switch indication at a modem processor directing the modem processor to utilize a designated subscriber information module (SIM);
means for identifying an access point name (APN) stored in the modem processor, the APN being associated with a network operator for the designated SIM; and
means for establishing a connection to a data network identified by the APN.

13. The apparatus of claim 12, further comprising:
means for retrieving a stored association between the APN and an identification (ID) of the designated SIM from the modem processor, wherein the APN is identified based on the association between the APN and the ID.

14. The apparatus of claim 12, further comprising:
means for establishing a prior connection to the data network associated with the APN; and
means for storing the APN in the modem processor based at least in part on the prior connection.

15. The apparatus of claim 12, further comprising:
means for storing a first set of APNs comprising the APN in the modem processor, wherein each APN of the first set of APNs is associated with the network operator for the designated SIM.

16. The apparatus of claim 15, further comprising:
means for storing a second set of APNs in the modem processor, wherein each APN of the second set of APNs is associated with a different network operator from the network operator for the designated SIM.

17. The apparatus of claim 12, wherein the switch indication comprises an instruction to switch from a prior SIM to the designated SIM.

18. The apparatus of claim 17, wherein the prior SIM is associated with a different network operator from the network operator for the designated SIM.

19. An apparatus for reducing attach delay for a multi-SIM user equipment (UE), comprising:
a processor;
memory in electronic communication with the processor; and
instructions stored in the memory, wherein the instructions are executable by the processor to:
receive a switch indication at a modem processor directing the modem processor to utilize a designated subscriber information module (SIM);
identify an access point name (APN) stored in the modem processor, the APN being associated with a network operator for the designated SIM; and
establish a connection to a data network identified by the APN.

20. The apparatus of claim 19, wherein the instructions are executable by the processor to:
retrieve a stored association between the APN and an identification (ID) of the designated SIM from the modem processor, wherein the APN is identified based on the association between the APN and the ID.

21. The apparatus of claim 19, wherein the instructions are executable by the processor to:
establish a prior connection to the data network associated with the APN; and
store the APN in the modem processor based at least in part on the prior connection.

22. The apparatus of claim 19, wherein the instructions are executable by the processor to:
store a first set of APNs comprising the APN in the modem processor, wherein each APN of the first set of APNs is associated with the network operator for the designated SIM.

23. The apparatus of claim 22, wherein the instructions are executable by the processor to:
store a second set of APNs in the modem processor, wherein each APN of the second set of APNs is associated with a different network operator from the network operator for the designated SIM.

24. The apparatus of claim 22, wherein the instructions are executable by the processor to:
identify a priority rule associated with the first set of APNs and the network operator for the designated SIM, wherein establishing the connection to the data network based at least in part on the priority rule.

25. The apparatus of claim 19, wherein the instructions are executable by the processor to:
access identification information from the designated SIM, wherein the identification information comprises an identifier of the network operator.

26. The apparatus of claim 19, wherein the instructions are executable by the processor to:
send the switch indication from an application processor of the UE.

27. The apparatus of claim 19, wherein the switch indication comprises an instruction to switch from a prior SIM to the designated SIM.

28. The apparatus of claim 27, wherein the prior SIM is associated with a different network operator from the network operator of the designated SIM.

29. The apparatus of claim 19, wherein the APN is associated with an internet protocol (IP) network, an operator application network, an administrative network, or an internet protocol multimedia subsystem (IMS) network.

30. A non-transitory computer-readable medium storing code for reducing attach delay for a multi-SIM user equipment (UE), the code comprising instructions executable by a processor to:
receive a switch indication at a modem processor directing the modem processor to utilize a designated subscriber information module (SIM);
identify an access point name (APN) stored in the modem processor, the APN being associated with a network operator for the designated SIM; and
establish a connection to a data network identified by the APN.
